(19) United States
(12) Patent Application Publication
(10) Pub. No.: US 2026/0017399 A1
(43) Pub. Date: Jan. 15, 2026

(54) METHOD AND APPARATUS FOR MOUNTING FILE SYSTEM, DEVICE AND STORAGE MEDIUM

(71) Applicant: Beijing Baidu Netcom Science Technology Co., Ltd., Beijing (CN)

(72) Inventors: Hao WANG, Beijing (CN); Liguo DUAN, Beijing (CN); Yan XING, Beijing (CN); Peng LIU, Beijing (CN); Mingyuan LIANG, Beijing (CN)

(21) Appl. No.: 19/330,747

(22) Filed: Sep. 16, 2025

(30) Foreign Application Priority Data
Feb. 20, 2025 (CN) 202510188858.3

(51) Int. Cl. G06F 21/62; H04L 9/40

(52) U.S. Cl. CPC G06F 21/6218; H04L 63/083

(57) ABSTRACT

A method and an apparatus for mounting a file system, a device, and a storage medium are provided. The method includes: detecting whether a mount request obtained from a client includes a target token; in response to determining that the target token is included, querying a target authorization record associated with the target token from candidate authorization records of candidate file systems, where the target authorization record includes a target identifier of the target file system; and feeding back the target identifier to the client, enabling the client to access the target file system using the target identifier.

### CROSS-REFERENCE TO RELATED APPLICATIONS

This application claims the priority from Chinese Patent Application No. 202510188858.3, filed on Feb. 20, 2025, the entire disclosure of which is hereby incorporated by reference.

### TECHNICAL FIELD

The present disclosure relates to the field of computer technologies, and in particular to the field of network file systems. Specifically, the present disclosure relates to a method for mounting a file system, a device, and a storage medium.

### BACKGROUND

File system mounting technology is a key component in the field of data access and sharing. Among them, the Network File System (NFS), as an important tool for sharing file directories between Linux systems, has greatly promoted flexible data access. NFS-Ganesha, an open-source software project, implements extensive support for various back-end distributed storage interfaces through file system functions in user space, and exposes standard file system semantics to clients, thereby enhancing system compatibility and usability.

However, current mounting via Ganesha to access NFS still fails to meet user needs for more fine-grained and flexible file access control.

### SUMMARY

The present disclosure provides a method for mounting a file system, a device, and a storage medium.

According to an aspect of the present disclosure, a method for mounting a file system is provided, executed by a file system server, the method including:
detecting whether a mount request obtained from a client includes a target token;
in response to determining that the target token is included, querying a target authorization record associated with the target token from candidate authorization records of candidate file systems, where the target authorization record includes a target identifier of the target file system; and
feeding back the target identifier to the client, enabling the client to access the target file system using the target identifier.

According to another aspect of the present disclosure, a method for mounting a file system is provided, executed by a client, the method including:
generating a mount request including a target token, and sending the mount request to a file system server, such that when the file system server detects that the mount request obtained from the client includes the target token, the file system server queries a target authorization record associated with the target token from candidate authorization records of candidate file systems, where the target authorization record includes a target identifier of the target file system;
obtaining the target identifier fed back by the file system server; and
accessing the target file system using the target identifier.

According to another aspect of the present disclosure, an electronic device is provided, the electronic device including:
at least one processor; and
a memory communicatively connected to the at least one processor;
   where
the memory stores instructions executable by the at least one processor, and the instructions are executed by the at least one processor to enable the at least one processor to perform the method provided in any embodiment of the present disclosure.

According to another aspect of the present disclosure, a non-transitory computer-readable storage medium storing computer instructions is provided, where the computer instructions are configured to cause a computer to perform the method provided in any embodiment of the present disclosure.

It should be understood that the content described in this section is not intended to identify key or essential features of the embodiments of the present disclosure, nor is it intended to limit the scope of the present disclosure. Other features of the present disclosure will become readily understood through the following description.

### BRIEF DESCRIPTION OF THE DRAWINGS

The accompanying drawings are used for better understanding of the solution and do not constitute a limitation to the present disclosure.

FIG. 1a is a flowchart of a method for mounting a file system according to an embodiment of the present disclosure;

FIG. 1b is a schematic structural diagram of a file system according to an embodiment of the present disclosure;

FIG. 2 is a flowchart of another method for mounting a file system according to an embodiment of the present disclosure;

FIG. 3a is a flowchart of yet another method for mounting a file system according to an embodiment of the present disclosure;

FIG. 3b is a schematic structural diagram of another file system according to an embodiment of the present disclosure;

FIG. 4 is a flowchart of yet another method for mounting a file system according to an embodiment of the present disclosure;

FIG. 5 is a flowchart of yet another method for mounting a file system according to an embodiment of the present disclosure;

FIG. 6 is a schematic structural diagram of an apparatus for mounting a file system according to an embodiment of the present disclosure;

FIG. 7 is a schematic structural diagram of another apparatus for mounting a file system according to an embodiment of the present disclosure;

FIG. 8 is a block diagram of an electronic device for implementing the method for mounting a file system according to an embodiment of the present disclosure.

### DETAILED DESCRIPTION

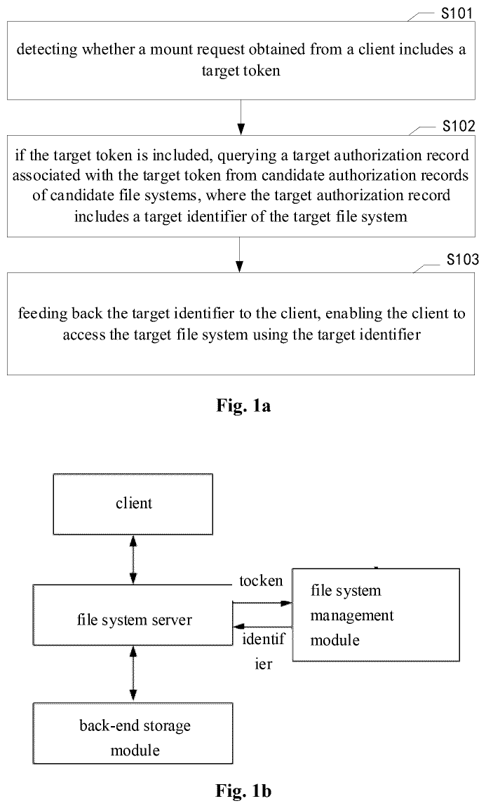

FIG. 1a is a flowchart of a method for mounting a file system according to an embodiment of the present disclosure. This method is applicable to scenarios where a user is allowed to mount to a specified network file system. The method may be executed by an apparatus for mounting a file system, which may be implemented in software and/or hardware and integrated into a file system server. The file system server may be an open-source NFS server supporting multiple versions of the NFS protocol (e.g., a Ganesha server). As shown in FIG. 1a, the method for mounting a file system in this embodiment may include the following steps.

S101 includes: detecting whether a mount request obtained from a client includes a target token.

S102 includes: in response to determining that the target token is included, querying a target authorization record associated with the target token from candidate authorization records of candidate file systems, where the target authorization record includes a target identifier of the target file system.

S103 includes: feeding back the target identifier to the client, enabling the client to access the target file system using the target identifier.

Referring to FIG. 1b, an NFS file system may include a client, a file system server (e.g., a Ganesha server), a back-end storage module, and a file system management module. The file system server is communicatively connected to the client, the back-end storage module, and the file system management module respectively. The back-end storage module is used to store directory information of candidate file systems and file data. Some candidate file systems in the back-end storage module may be based on the NFS protocol; others may be based on other protocols (e.g., CephFS, GlusterFS). Candidate file systems based on other protocols may be integrated with the NFS server through corresponding drivers or interfaces, enabling the NFS server to share data in these candidate file systems via the NFS protocol. The database of the file system management module may pre-store candidate authorization records of candidate file systems, including at least an association relationship between candidate identifiers of the candidate file systems and candidate tokens. A candidate identifier is a File System ID (fsid), and one candidate file system may have different candidate authorization records for different users (i.e., different users may use their respective candidate tokens to access the same candidate file system).

A mount request may include a request type, protocol version, server address, file system directory, and mount point directory. The “file system directory” refers to the directory in the candidate file system that needs to be mounted and accessed; the “mount point directory” refers to a directory in the local file system of the client, which serves as a mount point for the candidate file system in the candidate storage module. Once the mounting is successful, the client can access files and directories in the corresponding candidate file system in the back-end storage module by accessing the local mount point directory.

The “target token” refers to a token specified by the user in the mount request (e.g., a token input by the user). The target token may be included in the file system directory of the mount request. For example, the user may obtain candidate tokens for accessing at least one candidate file system in advance. When needing to mount to one of the candidate file systems (i.e., the target file system), the user may write the corresponding target token into the file system directory to generate a mount request, and send the mount request to the file system server.

The file system server obtains the mount request from the client and detects whether the mount request includes a target token. In response to determining that the mount request includes the target token, the file system server may query the target authorization record associated with the target token from the candidate authorization records of candidate file systems, where the target authorization record includes at least the target identifier of the target file system. Therefore, in response to determining that a target identifier associated with the target token is queried from the candidate authorization records, the target identifier is fed back to the client, enabling the client to access the corresponding directory in the target file system using the target identifier; and in response to determining that no target identifier associated with the target token exists in the candidate authorization records, the mount request is rejected.

One user may have multiple candidate tokens for different candidate file systems; a given user may also use a given candidate token to initiate mount requests on different clients to access a given candidate file system on different clients; different users may also access different candidate file systems on a given client. By obtaining the mount request from the client and detecting whether the mount request includes a user-specified target token, querying the target identifier associated with the target token in response to determining that the token is included, and feeding back the target identifier to the client, the client can access the corresponding directory in the target file system using the target identifier. In other words, by allowing the user to specify a target token in the mount request and modifying the file system server's logic for processing the mount request, flexible switching between different candidate file systems is achieved, improving the flexibility of file system mounting.

The technical solution provided by the embodiment of the present disclosure detects whether a mount request sent by a client includes a user-specified target token. In response to determining that the target token is included, the target authorization record associated with the target token is queried from the candidate authorization records of candidate file systems to obtain the target identifier associated with the target token. The target identifier is then fed back to the client, enabling the client to access the corresponding directory in the target file system using the target identifier. This achieves flexible switching between different candidate file systems and improves the flexibility of file system mounting.

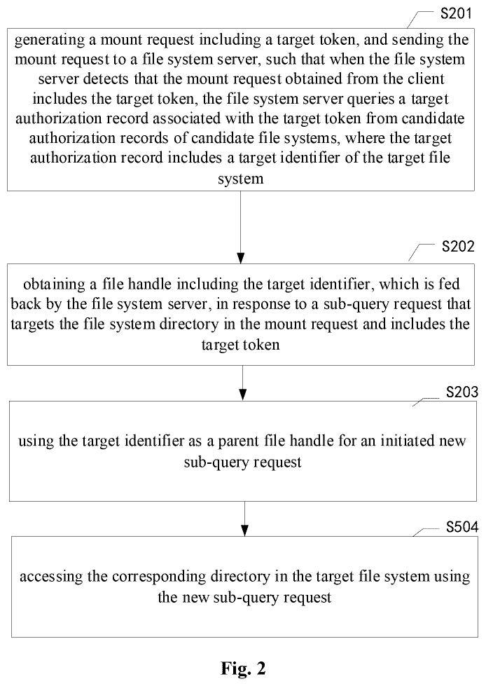

FIG. 2 is a flowchart of another method for mounting a file system according to an embodiment of the present disclosure. Referring to FIG. 2, further defined based on the above embodiment, the method for mounting a file system in this embodiment may include the following steps.

S201 includes: in response to a sub-query request for the file system directory in the mount request obtained from the client, detecting whether the sub-query request includes a token field;

S202 includes: in response to determining that the token field is included, extracting the value of the token field from the sub-query request to obtain the target token;

S203 includes: in response to determining that the target token is included, querying a target authorization record associated with the target token from candidate authorization records of candidate file systems, where the target authorization record includes a target identifier of the target file system;

S204 includes: feeding back the target identifier to the client, enabling the client to access the target file system using the target identifier.

The client may generate a mount request according to a user-specified target token. The client kernel may split the mount request into multiple sub-requests (e.g., a mount sub-request and sub-query (lookup) requests for each level of the file system directory) and send the sub-requests to the file system server in logical order.

During the processing of the file system server of the mount request, a root handler needs to be obtained in the mount sub-request processing phase (e.g., a fixed root handler may be returned uniformly to simplify the processing flow). The root handler is a handle for operating the root directory, and subsequent operations of the client on the target file system may be based on this handle. In the sub-query request processing phase, whether the sub-query request includes a specified token field (e.g., whether it includes “token=”) may be detected. In response to determining that the token field is included, the value of the token field is used as the target token. For example, for the sub-query request “token=9ed1608d”, the target token is “9ed1608d”. Exemplarily, the target token may be sent to the file system management module to query whether a target identifier (e.g., fsid=108) associated with the target token exists in the candidate authorization records of candidate file systems. The target identifier is then fed back to the client, enabling the client to access the target file system using the target identifier.

By detecting and extracting the value of the specified token field as the target token during the processing of the sub-query request, and querying the target identifier associated with the target token from the candidate authorization records of candidate file systems based on the token, the file system server can efficiently and accurately provide the client with permission to access the target file system, simplifying the user access process and enhancing system security.

In an optional implementation, the target token is located in the first-level directory of the file system in the mount request.

The mount request may include information such as request type, protocol version, server address, file system directory, and mount point directory. The file system directory may have a multi-level directory structure for the file system, and the target token is placed in the first-level directory of the file system. Other levels of the file system directory may correspond to actual directories in the target file system. For example, for the file system directory “token=9ed1608d/dir1”, the first-level directory “token=9ed1608d” includes the target token “9ed1608d”, and the second-level directory “/dir1” is an actual directory on the target file system. By placing the target token in the first-level directory of the file system, the file system server can first parse the target token, feed back the target identifier associated with the target token to the client, and then the client can access the actual directory in the target file system using the target identifier and the information of other optional levels of directories.

In an optional implementation, the feeding back the target identifier to the client to enable the client to access the target file system using the target identifier includes: creating a file handle according to the target identifier, feeding the file handle back to the client, and enabling the client to use the target identifier as a parent file handle for an initiated new sub-query request; and in response to the new sub-query request, accessing the corresponding directory in the target file system according to the target identifier.

Exemplarily, in response to determining that the sub-query request for the file system directory in the mount request includes the target token, the target identifier associated with the target token is queried and stored in the file handle returned to the client (e.g., the target identifier may be filled back into the File System Abstraction Layer (FSAL) handle of the file handle). When the client needs to initiate a new sub-query request for other levels of the file system directory, the target identifier may be used as the parent file handle (i.e., parent directory fh) of the new sub-query request and sent to the file system server. The file system server uses the target identifier in the parent file handle to identify and locate the corresponding target file system, and further accesses the actual directory in the target file system in the back-end storage module.

Taking the file system directory “token=9ed1608d/dir1” as an example: for the first-level directory “token=9ed1608d”, the file system server determines the target identifier “fsid=108” associated with the target token and stores the target identifier “fsid=108” in the file handle returned to the client. When the client initiates a new sub-query request for the second-level directory “/dir1”, the target identifier “fsid=108” is used as the parent file handle of the new sub-query request. It should be noted that for subsequent sub-query requests for other levels of directories, the target identifier “fsid=108” is also used as the parent file handle of the new sub-query request.

By storing the target identifier associated with the target token in the file handle fed back to the client, and enabling the client to use the target identifier as the parent file handle for subsequent new sub-query requests for other levels of the file system directory, the actual directory in the target file system can be quickly located and accessed without repeated verification and file system specification, thereby improving the efficiency and convenience of file access.

The technical solution provided by the embodiment of the present disclosure: when the sub-query request for the file system directory includes the target token, the file system server determines the target identifier associated with the target token, stores the target identifier in the file handle fed back to the client, and enables the client to use the target identifier as the parent file handle for subsequent new sub-query requests for other levels of the file system directory. This allows quick location and access to the actual directory in the target file system without repeated verification and file system specification, thereby improving the efficiency and convenience of file access.

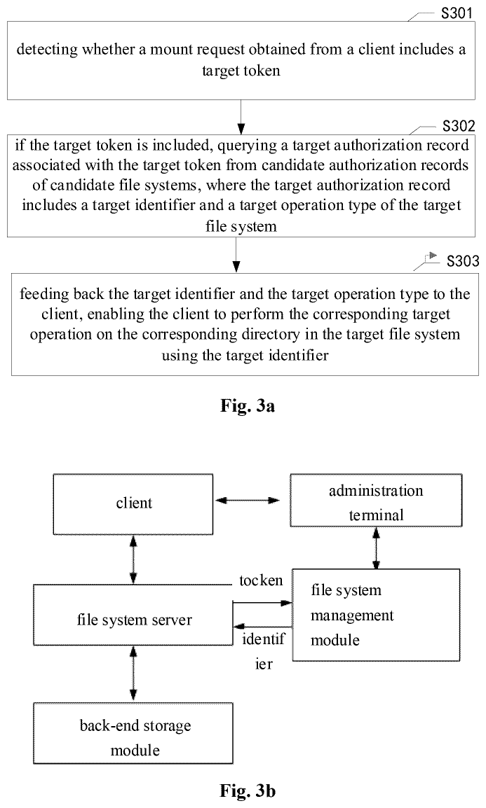

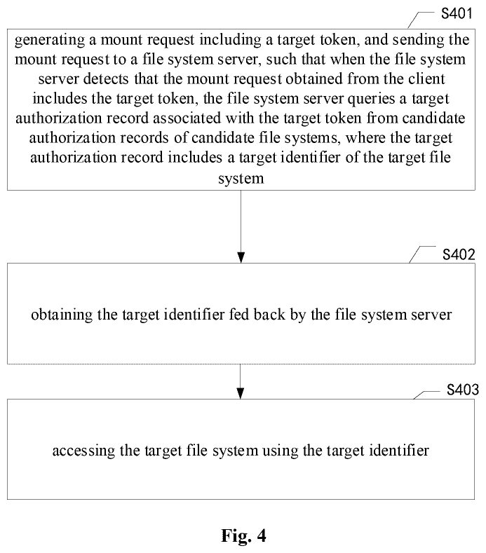

FIG. 3a is a flowchart of yet another method for mounting a file system according to an embodiment of the present disclosure. Referring to FIG. 3a, further defined based on the above embodiment, the method for mounting a file system in this embodiment may include the following steps.

S301 includes: detecting whether a mount request obtained from a client includes a target token.

S302 includes: in response to determining that the target token is included, querying a target authorization record associated with the target token from candidate authorization records of candidate file systems, where the target authorization record includes a target identifier and a target operation type of the target file system.

S303 includes: feeding back the target identifier and the target operation type to the client, enabling the client to perform the corresponding target operation on the corresponding directory in the target file system using the target identifier.

The target authorization record may include not only the target identifier but also a pre-authorized target operation type (e.g., read-only permission or read-write permission). In other words, the database of the file system management module may pre-store an association relationship between candidate identifiers, candidate operation types, and candidate tokens of candidate file systems.

When detecting that the mount request includes the target token, the file system server queries the target identifier and target operation type associated with the target token from the association relationship between candidate identifiers, candidate operation types, and candidate tokens, and feeds back the target identifier and target operation type to the client. After receiving the target identifier and target operation type, the client accesses the corresponding directory in the target file system using the target identifier and performs the corresponding target operation on the directory using the target operation type. Specifically, in response to determining that the target operation type is “read-only”, the client only performs read operations on the corresponding directory in the target file system and rejects write operations; in response to determining that the target operation type is “read-write”, the client may perform both read and write operations on the corresponding directory in the target file system. By specifying the operation type in the authorization record, the operation permissions of the client on the target file system can be precisely controlled, preventing unauthorized access and greatly improving the security of file access.

The technical solution provided by the embodiment of the present disclosure detects whether a mount request sent by a client includes a user-specified target token. In response to determining that the target token is included, the target authorization record associated with the target token is queried from the candidate authorization records of candidate file systems to obtain the target identifier and target operation type associated with the target token. The target identifier and target operation type are then fed back to the client, enabling the client to precisely control the operation permissions on the target file system using the target identifier and target operation type, further improving the security of file access.

In an optional implementation, the target authorization record further includes a target validity period; the method further includes: detecting whether the target token is invalid according to the target validity period; and in response to determining that the target token is invalid, rejecting the mount request.

The target authorization record may include not only the target identifier but also a target validity period. In other words, the database of the file system management module may pre-store an association relationship between candidate identifiers, candidate validity periods, and candidate tokens of candidate file systems.

When detecting that the mount request includes the target token, the file system server queries the target identifier and target validity period associated with the target token from the association relationship between candidate identifiers, candidate validity periods, and candidate tokens, and detects whether the target token is invalid according to the target validity period. In response to determining that the target token has expired, the mount request is rejected; in response to determining that the target token is still valid, the target identifier is fed back to the client, enabling the client to access the corresponding directory in the target file system using the target identifier. By specifying the validity period in the authorization record, the file system server can precisely verify whether the target token in the mount request is still within the validity period, effectively preventing unauthorized access to the target file system using expired tokens and further improving the security of file access.

In an optional implementation, the method further includes: obtaining and storing an association relationship between the target authorization record and the target token from an administration terminal, where the target authorization record is generated in response to an access authorization application submitted by the client for the target file system.

Referring to FIG. 3b, in addition to the client, file system server, back-end storage module, and file system management module, the NFS file system may further include an administration terminal, which is communicatively connected to the client and the file system management module respectively. Exemplarily, the client may send an access authorization application for the file system to the administration terminal. The access authorization application includes at least the target file system directory to be accessed. After the administrator grants authorization, a target token is generated, the association relationship between the target token and the target authorization record is stored in the database of the file system management module, and the target token is fed back to the client for the client to access the target file system using the target token.

The access authorization application may further include a target operation type and/or a target validity period. The client may send an access authorization application including the target file system directory to be accessed, as well as the target operation type and/or target validity period to the administration terminal. The administration terminal receives the access authorization application, authenticates the client, and in response to determining that the authentication is passed, generates a target access token for the client, writes the association relationship between the target file system directory, target access token, target operation type, and target validity period into the database of the file system management module (i.e., stores the association relationship between the target access token and the target authorization record), and feeds back the target access token to the client.

The access authorization application of the client may also include at least one of a candidate file system directory, a candidate operation type, and a candidate validity period. In response to determining that the administration terminal passes the authentication, it generates a candidate access token for the corresponding client, writes the association relationship between the candidate file system directory, candidate access token, candidate operation type, and candidate validity period into the database of the file system management module, and obtains the association relationship between the candidate access token and the candidate authorization record. Through the authorization application, only authorized users can access the corresponding file system directory, further improving the security and controllability of file access.

FIG. 4 is a flowchart of a method for mounting a file system according to an embodiment of the present disclosure. This method is applicable to scenarios where a user is allowed to mount to a specified network file system. The method may be executed by an apparatus for mounting a file system, which may be implemented in software and/or hardware and integrated into a client. As shown in FIG. 4, the method for mounting a file system in this embodiment may include following steps.

S401 includes: generating a mount request including a target token, and sending the mount request to a file system server, such that when the file system server detects that the mount request obtained from the client includes the target token, the file system server queries a target authorization record associated with the target token from candidate authorization records of candidate file systems, where the target authorization record includes a target identifier of the target file system.

S402 includes: obtaining the target identifier fed back by the file system server.

S403 includes: accessing the target file system using the target identifier.

The NFS file system may include a client, a file system server, a back-end storage module, and a file system management module. The file system server is communicatively connected to the client, the back-end storage module, and the file system management module respectively. The back-end storage module is used to store directory information of candidate file systems and file data. The database of the file system management module may pre-store candidate authorization records of candidate file systems, including at least an association relationship between candidate identifiers and candidate tokens of the candidate file systems. A candidate identifier is a File System ID (fsid), and one candidate file system may have different candidate authorization records for different users.

Exemplarily, the user may obtain candidate tokens for accessing at least one candidate file system in advance. When needing to mount to one of the candidate file systems (i.e., the target file system), the user may write the corresponding target token into the file system directory to generate a mount request, and send the mount request to the file system server. The file system server detects whether the mount request includes the target token; in response to determining that the mount request includes the target token, the file system server queries the target authorization record associated with the target token from the candidate authorization records of candidate file systems, where the target authorization record includes at least the target identifier of the target file system. The client obtains the target identifier fed back by the file system server and accesses the target file system using the target identifier. By writing the required target token into the mount request and sending the mount request including the target token to the file system server, the client enables the file system server to parse the target token from the mount request, query the target authorization record associated with the target token from the candidate authorization records to obtain at least the target identifier associated with the target token, and feed back the target identifier to the client. The client then accesses the corresponding directory in the target file system using the target identifier, achieving flexible switching between different candidate file systems and improving the flexibility of file system mounting.

The technical solution provided by the embodiment of the present disclosure: the client generates a mount request including a specified target token and sends the mount request to the file system server. The file system server parses the target token from the mount request, queries the target authorization record associated with the target token from the candidate authorization records to obtain at least the target identifier associated with the target token, and feeds back the target identifier to the client. The client accesses the corresponding directory in the target file system using the target identifier, achieving flexible switching between different candidate file systems and improving the flexibility of file system mounting.

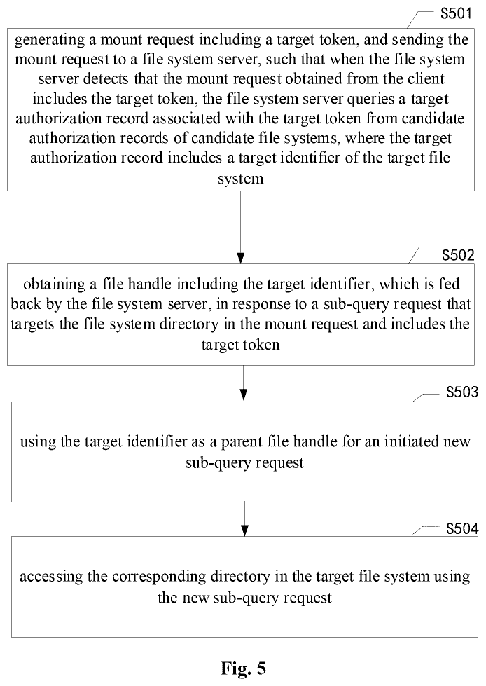

FIG. 5 is a flowchart of yet another method for mounting a file system according to an embodiment of the present disclosure. Referring to FIG. 5, further defined based on the above embodiment, the method for mounting a file system in this embodiment may include following steps.

S501 includes: generating a mount request including a target token, and sending the mount request to a file system server, such that when the file system server detects that the mount request obtained from the client includes the target token, the file system server queries a target authorization record associated with the target token from candidate authorization records of candidate file systems, where the target authorization record includes a target identifier of the target file system.

S502 includes: obtaining a file handle including the target identifier, which is fed back by the file system server, in response to a sub-query request that targets the file system directory in the mount request and includes the target token;

S503 includes: using the target identifier as a parent file handle for an initiated new sub-query request.

S504 includes: accessing the corresponding directory in the target file system using the new sub-query request.

The client may generate a mount request according to a user-specified target token. The client kernel may split the mount request into multiple sub-requests (e.g., a mount sub-request, and sub-query (lookup) requests for levels of the file system directory) and send the sub-requests to the file system server in logical order.

The client first sends a mount sub-request to the file system server, enabling the file system server to obtain a root handler (e.g., a fixed root handler may be returned uniformly to simplify the processing flow). Subsequent operations of the client on the target file system may be based on this handle. The client may send a sub-query request to the file system server, enabling the file system server to detect whether the sub-query request includes a specified token field (e.g., whether it includes “token=”). In response to determining that the token field is included, the value of the token field is used as the target token. For example, for the sub-query request “token=9ed1608d”, the target token is “9ed1608d”. Exemplarily, the client may send the target token to the file system management module to query whether a target identifier (e.g., fsid=108) associated with the target token exists in the candidate authorization records of candidate file systems. The file system server then feeds back the target identifier to the client, and the client accesses the target file system using the fed-back target identifier.

Exemplarily, in response to determining that the sub-query request sent by the client includes the target token, the file system server queries the target identifier associated with the target token and stores the target identifier in the file handle returned to the client (e.g., the target identifier may be filled back into the File System Abstraction Layer (FSAL) handle of the file handle). When the client needs to initiate a new sub-query request for other levels of the file system directory, the target identifier may be used as the parent file handle (i.e., parent directory fh) of the new sub-query request and sent to the file system server. The file system server uses the target identifier in the parent file handle to identify and locate the corresponding target file system, and further accesses the actual directory in the target file system in the back-end storage module.

Taking the file system directory “token=9ed1608d/dir1” as an example: the client sends a sub-query request for the first-level directory “token=9cd1608d”, enabling the file system server to determine the target identifier “fsid=108” associated with the target token and store the target identifier “fsid=108” in the file handle returned to the client. When the client initiates a new sub-query request for the second-level directory “/dir1”, the target identifier “fsid=108” is used as the parent file handle of the new sub-query request. For subsequent sub-query requests for other levels of directories, the client also uses the target identifier “fsid=108” as the parent file handle of the new sub-query request. By obtaining the target identifier associated with the target token from the file system server and using the target identifier as the parent file handle for subsequent new sub-query requests for other levels of the file system directory, the client can quickly locate and access the actual directory in the target file system without repeated verification and file system specification, thereby improving the efficiency and convenience of file access.

The technical solution provided by the embodiment of the present disclosure: the client may initiate a sub-query request that targets the file system directory and includes the target token, enabling the file system server to feed back the target identifier associated with the target token. The client may use the target identifier as the parent file handle for subsequent new sub-query requests for other levels of the file system directory, allowing quick location and access to the actual directory in the target file system without repeated verification and file system specification, thereby improving the efficiency and convenience of file access.

In an optional implementation, the target token is located in the first-level directory of the file system in the mount request.

The mount request may include information such as request type, protocol version, server address, file system directory, and mount point directory. The file system directory may have a multi-level directory structure for the file system, and the target token is placed in the first-level directory of the file system. Other levels of the file system directory may correspond to actual directories in the target file system. For example, for the mount request “mount-t nfs4 127.0.0.1/token=9ed1608d/dir1/home/temp”, the file system directory is “token=9ed1608d/dir1”, the first-level directory “token=9ed1608d” includes the target token “9ed1608d”, and the second-level directory “/dir1” is an actual directory on the target file system. By placing the target token in the first-level directory of the file system, the file system server can first parse the target token, feed back the target identifier associated with the target token to the client, and then the client can access the actual directory in the target file system using the target identifier and the information of other optional levels of directories.

In an optional implementation, the target authorization record further includes a target operation type; the obtaining the target identifier fed back by the file system server includes: obtaining the target identifier and the target operation type fed back by the file system server; and according to the target operation type, allowing the client to perform the corresponding target operation on the target file system using the target identifier.

The target authorization record may include not only the target identifier but also a pre-authorized target operation type (e.g., read-only permission or read-write permission). In other words, the database of the file system management module may pre-store an association relationship between candidate identifiers, candidate operation types, and candidate tokens of candidate file systems.

When detecting that the mount request includes the target token, the file system server queries the target authorization record associated with the target token from the association relationship between candidate tokens and candidate authorization records (the target authorization record may include the target identifier and target operation type). The client obtains the target identifier and target operation type fed back by the file system server, accesses the corresponding directory in the target file system using the target identifier, and performs the corresponding target operation on the directory using the target operation type. Specifically, in response to determining that the target operation type is “read-only”, the client only performs read operations on the corresponding directory in the target file system and rejects write operations; in response to determining that the target operation type is “read-write”, the client may perform both read and write operations on the corresponding directory in the target file system. By specifying the operation type in the authorization record, the client operation permissions on the target file system can be precisely controlled, preventing unauthorized access and greatly improving the security of file access.

In an optional implementation, the method further includes: sending an access authorization application for the target file system to an administration terminal, such that the administration terminal authorizes the generation of a target authorization record including the target token and establishes an association relationship between the target authorization record and the target token; obtaining the target token fed back by the administration terminal.

In addition to the client, file system server, back-end storage module, and file system management module, the NFS file system may further include an administration terminal, which is communicatively connected to the client and the file system management module respectively. Exemplarily, the client may send an access authorization application for the file system to the administration terminal. The access authorization application includes at least the target file system directory to be accessed. After the administrator grants authorization, a target token is generated, the association relationship between the target token and the target authorization record is stored in the database of the file system management module, and the target token is fed back to the client for the client to access the target file system using the target token.

The access authorization application may further include a target operation type and/or a target validity period. The client may send an access authorization application including the target file system directory to be accessed, as well as the target operation type and/or target validity period to the administration terminal. The administration terminal receives the access authorization application, authenticates the client, and in response to determining that the authentication is passed, generates a target access token for the client, writes the association relationship between the target file system directory, target access token, target operation type, and target validity period into the database of the file system management module (i.e., stores the association relationship between the target access token and the target authorization record), and feeds back the target access token to the client.

Furthermore, the client access authorization application includes at least one of a candidate file system directory, a candidate operation type, and a candidate validity period. In response to determining that the administration terminal passes the authentication, it generates a candidate access token for the corresponding client, writes the association relationship between the candidate file system directory, candidate access token, candidate operation type, and candidate validity period into the database of the file system management module, and obtains the association relationship between the candidate access token and the candidate authorization record. In other words, the user may send an access authorization application to the administration terminal via the client. The access authorization application includes at least the candidate file system directory to be accessed, and may also include the required candidate operation type and/or candidate validity period. After the administration terminal passes the authentication (e.g., determines that the user has supervision permissions for the candidate file system), it generates a candidate token for the user for the candidate file system. The administration terminal also feeds back the candidate token to the client (enabling the client to initiate a mount request using the corresponding token) and stores the association relationship between the candidate authorization record and the candidate token in the database of the file system management module (the candidate authorization record includes at least the candidate file system directory). Through the authorization application, only authorized users can access the corresponding file system directory, further improving the security and controllability of file access.

FIG. 6 is a schematic structural diagram of an apparatus for mounting a file system according to an embodiment of the present disclosure. This apparatus is applicable to scenarios where a user is allowed to mount to a specified network file system. The apparatus may be implemented in software and/or hardware and integrated into a file system server. As shown in FIG. 6, the apparatus for mounting a file system in this embodiment may include:
a token detection module 610, configured to detect whether a mount request obtained from a client includes a target token;
a record query module 620, configured to query a target authorization record associated with the target token from candidate authorization records of candidate file systems in response to determining that the target token is included, where the target authorization record includes a target identifier of the target file system; and
an identifier sending module 630, configured to feed back the target identifier to the client, enabling the client to access the target file system using the target identifier.

In an optional implementation, the target token is located in the first-level directory of the file system in the mount request.

In an optional implementation, the token detection module 610 includes:
a token field unit, configured to detect whether a sub-query request includes a token field in response to the sub-query request for the file system directory in the mount request obtained from the client;
a token extraction unit, configured to extract the value of the token field from the sub-query request to obtain the target token in response to determining that the token field is included.

In an optional implementation, the identifier sending module includes:
a file handle unit, configured to create a file handle according to the target identifier, feed the file handle back to the client, and enable the client to use the target identifier as a parent file handle for an initiated new sub-query request;
a directory access unit, configured to access the corresponding directory in the target file system according to the target identifier in response to the new sub-query request.

In an optional implementation, the target authorization record further includes a target operation type;
the identifier sending module 630 is specifically configured to:
feed back the target identifier and the target operation type to the client, enabling the client to be allowed to perform the corresponding target operation on the corresponding directory in the target file system using the target identifier.

In an optional implementation, the target authorization record further includes a target validity period; and the apparatus 600 for mounting a file system further includes:
a token invalidation module, configured to detect whether the target token is invalid according to the target validity period; and in response to determining that the target token is invalid, reject the mount request.

According to an embodiment of the disclosure, the apparatus further includes:
a record storage module, configured to obtain and store an association relationship between the target authorization record and the target token from an administration terminal, where the target authorization record is generated in response to an access authorization application submitted by the client for the target file system.

The apparatus for mounting a file system provided by the embodiment of the present invention may execute the method for mounting a file system provided by any embodiment of the present disclosure, and has corresponding functional modules and beneficial effects for executing the method.

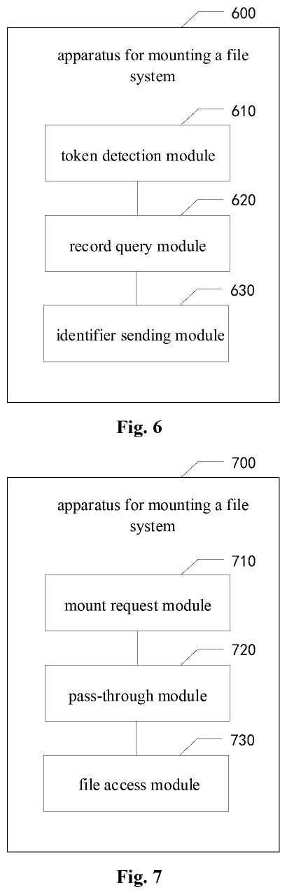

FIG. 7 is a schematic structural diagram of an apparatus for mounting a file system according to an embodiment of the present disclosure. This apparatus is applicable to scenarios where a user is allowed to mount to a specified network file system. The apparatus may be implemented in software and/or hardware and integrated into a client. As shown in FIG. 7, the apparatus for mounting a file system in this embodiment may include:
a mount request module 710, configured to generate a mount request including a target token and send the mount request to a file system server, such that when the file system server detects that the mount request obtained from the client includes the target token, the file system server queries a target authorization record associated with the target token from candidate authorization records of candidate file systems, where the target authorization record includes a target identifier of the target file system;
an identifier feedback module 720, configured to obtain the target identifier fed back by the file system server; and
a file access module 730, configured to access the target file system using the target identifier.

In an optional implementation, the target token is located in the first-level directory of the file system in the mount request.

In an optional implementation, the identifier feedback module 720 includes:
a file handle unit, configured to obtain a file handle including the target identifier, which is fed back by the file system server in response to a sub-query request that targets the file system directory in the mount request and includes the target token;
the file access module 730 includes:
a new request initiation module, configured to use the target identifier as a parent file handle for an initiated new sub-query request;
a file access unit, configured to access the corresponding directory in the target file system using the new sub-query request.

In an optional implementation, the target authorization record further includes a target operation type;
the identifier feedback module 720 includes:
an identifier feedback unit, configured to obtain the target identifier and
the target operation type fed back by the file system server;
a target operation unit, configured to allow the client to perform the corresponding target operation on the target file system using the target identifier according to the target operation type.

In an optional implementation, the apparatus 700 for mounting a file system further includes an access authorization module, and the access authorization module includes:
an authorization application unit, configured to send an access authorization application for the target file system to an administration terminal, such that the administration terminal authorizes the generation of a target authorization record including the target token and establishes an association relationship between the target authorization record and the target token;
a target token unit, configured to obtain the target token fed back by the administration terminal.

The apparatus for mounting a file system provided by the embodiment of the present disclosure may execute the method for mounting a file system provided by any embodiment of the present disclosure, and has corresponding functional modules and beneficial effects for executing the method.

In the technical solution of the present disclosure, the acquisition, storage, and application of user personal information all comply with relevant laws and regulations and do not violate public order and good morals.

According to the embodiments of the present disclosure, the present disclosure further provides an electronic device, a readable storage medium, and a computer program product.

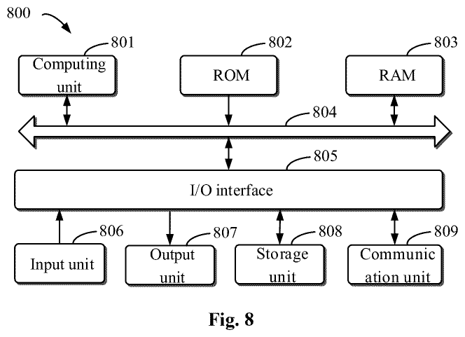

FIG. 8 is a block diagram of an electronic device for implementing the method for mounting a file system according to an embodiment of the present disclosure. FIG. 8 shows a schematic block diagram of an example electronic device that may be used to implement the embodiments of the present disclosure. The electronic device is intended to represent various forms of digital computers, such as laptops, desktops, workstations, personal digital assistants, servers, blade servers, mainframes, and other suitable computers. The electronic device may also represent various forms of mobile devices, such as personal digital assistants, cellular phones, smartphones, wearable devices, and other similar computing devices. The components shown herein, their connections and relationships, and their functions are merely examples and are not intended to limit the implementation of the disclosure described and/or claimed herein.

As shown in FIG. 8, the electronic device 800 includes a computing unit 801, which can perform various appropriate actions and processes according to a computer program stored in a read-only memory (ROM) 802 or a computer program loaded from a storage unit into a random access memory (RAM) 803. In the RAM 803, various programs and data required for the operation of the electronic device 800 can also be stored. The computing unit 801, ROM 802, and RAM 803 are connected to each other via a bus. An input/output (I/O) interface 805 is also connected to the bus 804.

A plurality of components in the electronic device are connected to the I/O interface 805, including: an input unit 806 (e.g., a keyboard, a mouse); an output unit 807 (e.g., various types of displays, speakers); a storage unit 808 (e.g., a magnetic disk, an optical disk); and a communication unit 809 (e.g., a network card, a modem, a wireless communication transceiver). The communication unit 809 allows the electronic device 800 to exchange information/data with other devices via a computer network such as the Internet and/or various telecommunications networks.

The computing unit 801 may be various general-purpose and/or special-purpose processing components with processing and computing capabilities. Examples of the computing unit 801 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 801 executes the various methods and processes described above, such as the method for mounting a file system. For example, in some embodiments, the method for mounting a file system may be implemented as a computer software program tangibly embodied in a machine-readable medium such as the storage unit 808. In some embodiments, part or all of the computer program may be loaded and/or installed on the electronic device via the ROM 802 and/or the communication unit 809. When the computer program is loaded into the RAM 803 and executed by the computing unit 801, one or more steps of the method for mounting a file system described above may be executed. Alternatively, in other embodiments, the computing unit may be configured to execute the method for mounting a file system by any other suitable means (e.g., via firmware).

Various implementations of the systems and techniques described herein may be implemented in digital electronic circuit systems, integrated circuit systems, field-programmable gate arrays (FPGAs), application-specific integrated circuits (ASICs), application-specific standard products (ASSPs), system-on-a-chip (SoC) systems, complex programmable logic devices (CPLDs), computer hardware, firmware, software, and/or combinations thereof. These various implementations may include: being implemented in one or more computer programs that can be executed and/or interpreted on a programmable system including at least one programmable processor (which may be a dedicated or general-purpose programmable processor) that can receive data and instructions from a storage system, at least one input device, and at least one output device, and transmit data and instructions to the storage system, the at least one input device, and the at least one output device.

Program code for implementing the methods of the present disclosure may be written in any combination of one or more programming languages. These program codes may be provided to a processor or controller of a general-purpose computer, a special-purpose computer, or other programmable data processing apparatus, such that the program codes, when executed by the processor or controller, cause the functions/operations specified in the flowcharts and/or block diagrams to be implemented. The program codes may be executed entirely on the machine, partially on the machine, partially on the machine and partially on a remote machine, or entirely on the remote machine or server.

In the context of the present disclosure, a machine-readable medium may be a tangible medium that can contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. More specific examples of machine-readable storage media include one or more wire-based electrical connections, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

To provide interaction with a user, the systems and techniques described herein may be implemented on a computer having: a display device (e.g., a cathode ray tube (CRT) or a liquid crystal display (LCD) monitor) for displaying information to the user; and a keyboard and a pointing device (e.g., a mouse or a trackball) through which the user can provide input to the computer. Other types of devices may also be used to provide interaction with the user; for example, feedback provided to the user may be any form of sensory feedback (e.g., visual feedback, auditory feedback, or tactile feedback); and input from the user may be received in any form, including acoustic input, voice input, or tactile input.

The systems and techniques described herein may be implemented in a computing system that includes a back-end component (e.g., as a data server), or a middleware component (e.g., an application server), or a front-end component (e.g., a user computer having a graphical user interface or a web browser through which the user can interact with implementations of the systems and techniques described herein), or any combination of such back-end, middleware, or front-end components. The components of the system may be interconnected by any form or medium of digital data communication (e.g., a communication network). Examples of communication networks include a local area network (LAN), a wide area network (WAN), and the Internet.

A computer system may include a client and a server. The client and server are typically remote from each other and typically interact through a communication network. The relationship between the client and the server is generated by computer programs running on the respective computers and having a client-server relationship with each other. The server may be a cloud server, a server of a distributed system, or a server incorporating a blockchain.

Artificial intelligence (AI) is a discipline that studies how to make computers simulate human thinking processes and intelligent behaviors (such as learning, reasoning, thinking, and planning). It includes both hardware-level technologies and software-level technologies. AI hardware technologies generally include technologies such as sensors, dedicated AI chips, cloud computing, distributed storage, and big data processing; AI software technologies mainly include computer vision technologies, speech recognition technologies, natural language processing technologies, machine learning/deep learning technologies, big data processing technologies, and knowledge graph technologies.

Cloud computing refers to a technical system that accesses elastic and scalable shared physical or virtual resource pools through a network, where the resources may include servers, operating systems, networks, software, applications, and storage devices, and can be deployed and managed in a on-demand and self-service manner. Through cloud computing technologies, efficient and powerful data processing capabilities can be provided for the application and model training of technologies such as AI and blockchain.

It should be understood that the various forms of processes shown above can be reordered, added, or deleted. For example, the steps described in the present disclosure can be executed in parallel, sequentially, or in a different order, as long as the desired results of the technical solution of the present disclosure can be achieved, and no limitation is imposed herein.

The specific implementations described above do not limit the protection scope of the present disclosure. It will be apparent to those skilled in the art that various modifications, combinations, sub-combinations, and substitutions can be made based on design requirements and other factors. Any modifications, equivalent substitutions, and improvements made within the spirit and principles of the present disclosure should be included in the protection scope of the present disclosure.

What is claimed is:

1. A method for mounting a file system, executed by a file system server, the method comprising:
detecting whether a mount request obtained from a client includes a target token;
in response to determining that the target token is included, querying a target authorization record associated with the target token from candidate authorization records of candidate file systems, wherein the target authorization record includes a target identifier of the target file system; and
feeding back the target identifier to the client, enabling the client to access the target file system using the target identifier.

2. The method according to claim 1, wherein the target token is located in a first-level directory of the file system in the mount request.

3. The method according to claim 1, wherein the detecting whether the mount request obtained from the client includes the target token further comprises:
in response to a sub-query request for the file system directory in the mount request obtained from the client, detecting whether the sub-query request includes a token field; and
in response to determining that the token field is included, extracting a value of the token field from the sub-query request to obtain the target token.

4. The method according to claim 3, wherein the feeding back the target identifier to the client to enable the client to access the target file system using the target identifier further comprises:
creating a file handle according to the target identifier, feeding the file handle back to the client, and enabling the client to use the target identifier as a parent file handle for an initiated new sub-query request; and
in response to the new sub-query request, accessing a corresponding directory in the target file system according to the target identifier.

5. The method according to claim 1, wherein the target authorization record further includes a target operation type and wherein the feeding back the target identifier to the client to enable the client to access the target file system using the target identifier comprises feeding back the target identifier and the target operation type to the client, enabling the client to be allowed to perform a corresponding target operation on a corresponding directory in the target file system using the target identifier.

6. The method according to claim 1, wherein the target authorization record further comprises a target validity period and wherein the method further comprises detecting whether the target token is invalid according to the target validity period and in response to determining that the target token is invalid, rejecting the mount request.

7. The method according to claim 1, further comprising:
obtaining and storing an association relationship between the target authorization record and the target token from an administration terminal, wherein the target authorization record is generated in response to an access authorization application submitted by the client for the target file system.

8. A method for mounting a file system executed by a client, the method comprising:
generating a mount request including a target token, and sending the mount request to a file system server, such that when the file system server detects that the mount request obtained from the client includes the target token, the file system server queries a target authorization record associated with the target token from candidate authorization records of candidate file systems, where the target authorization record comprises a target identifier of the target file system;
obtaining the target identifier fed back by the file system server; and
accessing the target file system using the target identifier.

9. The method according to claim 8, wherein the target token is located in a first-level directory of the file system in the mount request.

10. The method according to claim 8, wherein the obtaining the target identifier fed back by the file system server comprises:
obtaining a file handle including the target identifier, fed back by the file system server in response to a sub-query request that targets the file system directory in the mount request and includes the target token;
wherein accessing the target file system using the target identifier comprises:
using the target identifier as a parent file handle for an initiated new sub-query request, and
accessing the corresponding directory in the target file system using the new sub-query request.

11. The method according to claim 8, wherein the target authorization record further comprises a target operation type;
wherein obtaining the target identifier fed back by the file system server comprises:
obtaining the target identifier and the target operation type fed back by the file system server, and
according to the target operation type, allowing the client to perform the corresponding target operation on the target file system using the target identifier.

12. The method according to claim 8, further comprising:
sending an access authorization application for the target file system to an administration terminal such that the administration terminal authorizes generation of a target authorization record comprising the target token and establishes an association relationship between the target authorization record and the target token; and
obtaining the target token fed back by the administration terminal.

13. An electronic device, comprising:
at least one processor; and
a memory communicatively connected to the at least one processor; wherein the memory is configured to store instructions executable by the at least one processor, and the instructions are configured to be executed by the at least one processor to perform operations comprising:
detecting whether a mount request obtained from a client includes a target token;
in response to determining that the target token is included, querying a target authorization record associated with the target token from candidate authorization records of candidate file systems, wherein the target authorization record includes a target identifier of the target file system; and
feeding back the target identifier to the client, enabling the client to access the target file system using the target identifier.

14. The electronic device according to claim 13, wherein the target token is located in a first-level directory of the file system in the mount request.

15. The electronic device according to claim 13, wherein the detecting whether the mount request obtained from the client includes the target token comprises:
in response to a sub-query request for the file system directory in the mount request obtained from the client, detecting whether the sub-query request includes a token field; and
in response to determining that the token field is included, extracting a value of the token field from the sub-query request to obtain the target token.

16. The electronic device according to claim 15, wherein the feeding back the target identifier to the client to enable the client to access the target file system using the target identifier comprises:
creating a file handle according to the target identifier, feeding the file handle back to the client, and enabling the client to use the target identifier as a parent file handle for an initiated new sub-query request; and
in response to the new sub-query request, accessing a corresponding directory in the target file system according to the target identifier.

17. The electronic device according to claim 13, wherein the target authorization record further includes a target operation type;
wherein the feeding back the target identifier to the client to enable the client to access the target file system using the target identifier comprises feeding back the target identifier and the target operation type to the client, enabling the client to be allowed to perform a corresponding target operation on a corresponding directory in the target file system using the target identifier.

18. An electronic device, comprising:
at least one processor; and
a memory communicatively connected to the at least one processor; wherein the memory is configured to store instructions executable by the at least one processor, the instructions executed by the at least one processor according to the method of claim 8.

19. A non-transitory computer-readable storage medium storing computer instructions, wherein the computer instructions are configured to cause a computer to perform the method according to claim 1.

20. A non-transitory computer-readable storage medium storing computer instructions, wherein the computer instructions are configured to cause a computer to perform the method according to claim 8.
